(19) United States
(12) Patent Application Publication
(10) Pub. No.: US 2026/0102882 A1
(43) Pub. Date: Apr. 16, 2026

(54) DIRECTION-REVERSING DETENT STRUCTURE FOR RATCHET WRENCHES

(71) Applicant: TSUNG-TE LIN, Taichung City (TW)

(72) Inventor: TSUNG-TE LIN, Taichung City (TW)

(21) Appl. No.: 19/334,049

(22) Filed: Sep. 19, 2025

(30) Foreign Application Priority Data
Oct. 16, 2024 (TW) 113139320

(51) Int. Cl. B25B 13/46

(52) U.S. Cl. CPC B25B 13/463

(57) ABSTRACT

A direction-reversing detent structure for ratchet wrenches is disclosed. The ratchet wrench includes a ratchet gear configured to connect with a driven tool, a lateral outer periphery of the ratchet gear being formed with ratchet teeth. The detent structure comprises a pawl, a reversing lever, a detent plunger, and a detent spring. The pawl is interposed between the ratchet gear and the reversing lever and has a tooth-engaging side adjacent to the ratchet gear and a cam side formed with cam surfaces. The reversing lever defines a bore that receives the detent plunger and the detent spring. An axial end of the detent plunger forms a contact surface that selectively engages the cam surfaces. The detent spring urges the contact surface into linear contact with one of the cam surfaces, thereby enhancing engagement stability and facilitating reliable direction reversal.

### FIELD OF INVENTION

The present invention relates to a component of a ratchet wrench, and more particularly to a direction-reversing detent structure configured for use in ratchet wrenches.

### BACKGROUND OF THE INVENTION

A conventional ratchet wrench is a tool that operates in a unidirectional ratcheting action and is primarily employed for driving a socket to rotate unidirectionally. The ratchet wrench typically comprises a handle, a ratchet head, and a ratchet mechanism. The handle carries both the ratchet head and the ratchet mechanism. The ratchet head is adapted for socket-connection with a socket, which in turn is configured to receive and engage a head of a bolt or a nut. A radial outer periphery of the ratchet head is formed with a plurality of ratchet teeth. The ratchet mechanism includes a pawl and a reversing member. The pawl is disposed adjacent to a radial peripheral side of the ratchet head. A side of the pawl facing toward the ratchet head is formed with a plurality of pawl teeth. The reversing member bears against a side of the pawl facing away from the ratchet head, such that a portion of the ratchet teeth engages a portion of the pawl teeth. In this manner, the pawl restricts the ratchet head to rotate in a single direction. By changing a position at which the reversing member bears against the pawl, the pawl is caused to rotate, thereby selecting another portion of the ratchet teeth to engage another portion of the pawl teeth, and consequently reversing the direction in which the pawl restricts the ratchet head to rotate.

In such conventional configurations, the pawl and the ratchet head are only partially engaged. During the process of changing the direction in which the pawl restricts the ratchet head to rotate, a portion of the pawl teeth tends to disengage from corresponding ones of the ratchet teeth, while another portion of the pawl teeth tends to newly engage the corresponding ones of the ratchet teeth. Consequently, a plurality of gaps is formed between each of the pawl teeth and its corresponding ratchet teeth. To facilitate sliding movement of one end of the reversing member relative to the pawl for changing its position, the one end of the reversing member is typically formed in a ball-shaped end that bears against a central portion of the pawl in a thickness direction. This arrangement allows the pawl to slightly rotate in the thickness direction about the part contacted by the reversing member, thereby adversely affecting the stability of the engagement between the pawl and the ratchet head. As a result, the ratchet teeth and the pawl teeth may fail to achieve complete engagement. When an acting force transmitted from the bolt or the nut through the socket is applied to the ratchet head, such incomplete engagement may lead to structural failure of a portion of the ratchet teeth or a portion of the pawl teeth.

### SUMMARY OF THE INVENTION

A primary object of the present invention is to provide a direction-reversing detent structure for ratchet wrenches.

To achieve the foregoing object, the present invention provides a direction-reversing detent structure disposed in a ratchet wrench, wherein the ratchet wrench comprises a ratchet gear. The ratchet gear is configured to receive and drive a driven tool, and a lateral outer periphery of the ratchet gear is formed with a plurality of ratchet teeth.

The direction-reversing detent structure comprises a pawl, a reversing lever, a detent plunger, and a detent spring. The pawl is interposed between the ratchet gear and the reversing lever.

The pawl has a tooth-engaging side and a cam side that are opposite to each other. The tooth-engaging side is adjacent to an outer surface of the ratchet gear and is formed with a plurality of pawl teeth. A selected plurality of the pawl teeth is configured to selectively engage corresponding ones of the ratchet teeth. The cam side of the pawl is formed with a first cam surface and a second cam surface.

The reversing lever is disposed adjacent to the cam side of the pawl. The reversing lever defines a bore that extends from an end of the reversing lever proximate to the cam side of the pawl into an interior of the reversing lever, wherein the bore is closed at an end of the reversing lever distal from the cam side.

The detent plunger and the detent spring are disposed within the bore. The reversing lever defines the bore and provides a cylindrical bore wall that surrounds a radial outer periphery of the detent plunger, thereby permitting the detent plunger to rotate about its axial direction. An axial end of the detent plunger extends outwardly from the reversing lever to form a contact surface, the contact surface being configured to selectively engage the first cam surface or the second cam surface. The detent spring resiliently engages both the detent plunger and the reversing lever so as to urge the contact surface into engagement with either the first cam surface or the second cam surface.

Each of the pawl teeth, the first cam surface, and the second cam surface extends along a first direction. An axial direction of the detent plunger and the bore extends along a second direction. The tooth-engaging side and the cam side of the pawl are spaced apart along the second direction. The first direction is orthogonal to the second direction.

The contact surface of the detent plunger has an arcuate profile and extends along the first direction. A central portion of the contact surface is closer to the cam side of the pawl than are opposite end portions of the contact surface. This arrangement enables the contact surface and the first cam surface or the second cam surface to establish linear contact along the first direction.

Through the linear contact between the contact surface and the first cam surface, stability of the engagement between the pawl and the ratchet gear is improved. The plurality of pawl teeth and the plurality of ratchet teeth that establish engagement between the pawl and the ratchet gear are thereby enabled to form a complete engagement, such that each of the ratchet teeth and each of the pawl teeth are less prone to structural damage.

### BRIEF DESCRIPTION OF THE DRAWINGS

FIG. 1 is a perspective view of Embodiment 1 of the present invention assembled with the ratchet gear.

FIG. 2 is an exploded perspective view of Embodiment 1 of the present invention and the ratchet gear.

FIG. 3 is a perspective view of the detent plunger of Embodiment 1 of the present invention from another viewing angle.

FIG. 4 is a top view of the pawl of Embodiment 1 of the present invention.

FIG. 5 is a sectional schematic view of Embodiment 1 of the present invention and the ratchet gear.

FIG. 6 is an enlarged partial view of FIG. 5.

FIG. 7 is a sectional view taken along line 7-7 of FIG. 5.

FIG. 8 is a sectional schematic view of Embodiment 2 of the present invention and the ratchet gear.

FIG. 9 is a sectional schematic view of Embodiment 3 of the present invention and the ratchet gear.

### DETAILED DESCRIPTION OF THE PREFERRED EMBODIMENTS

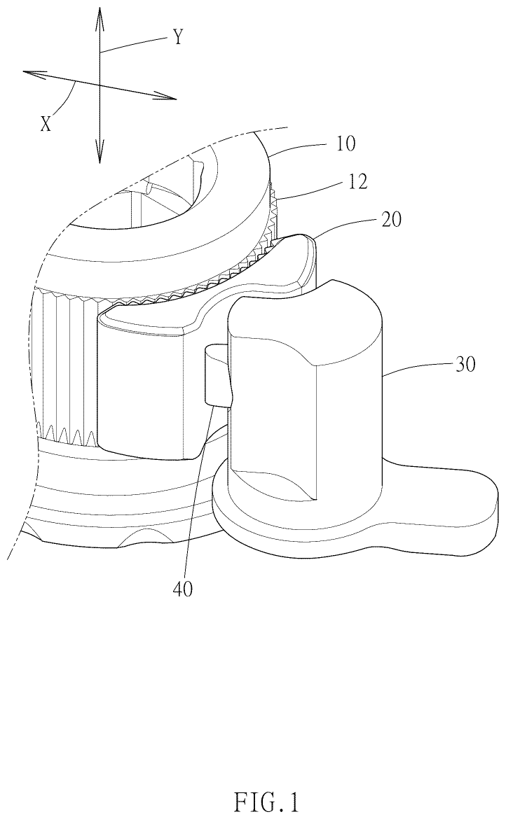

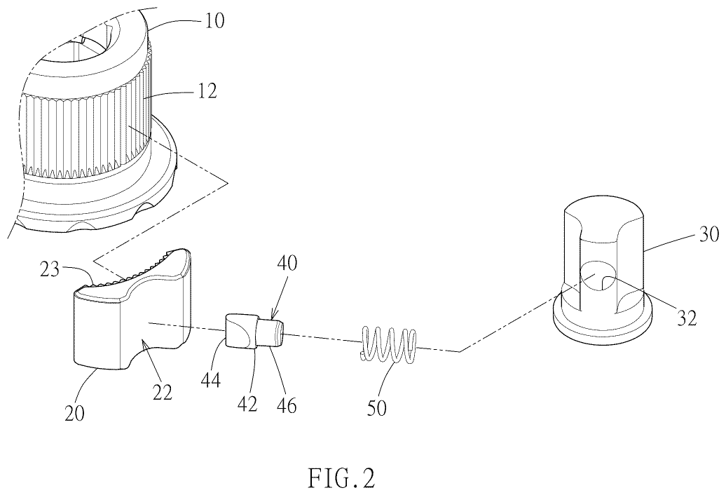

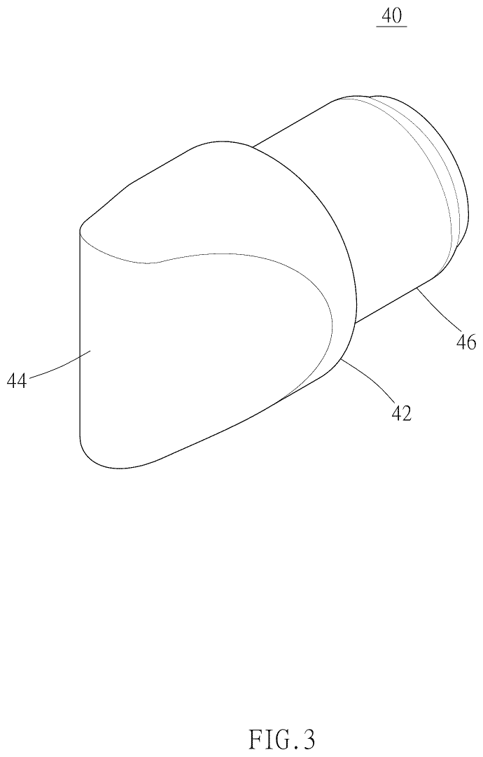

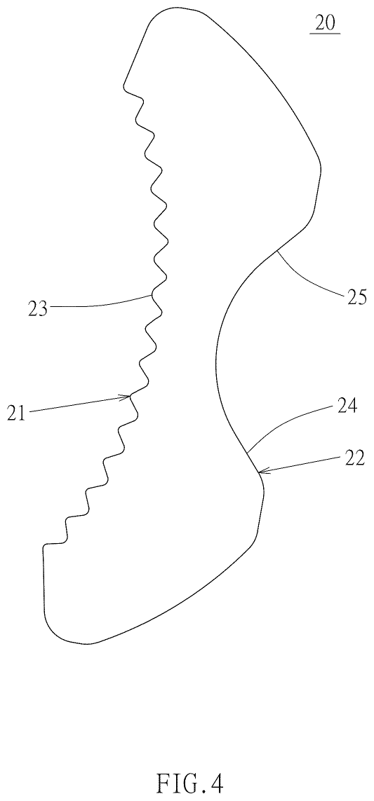

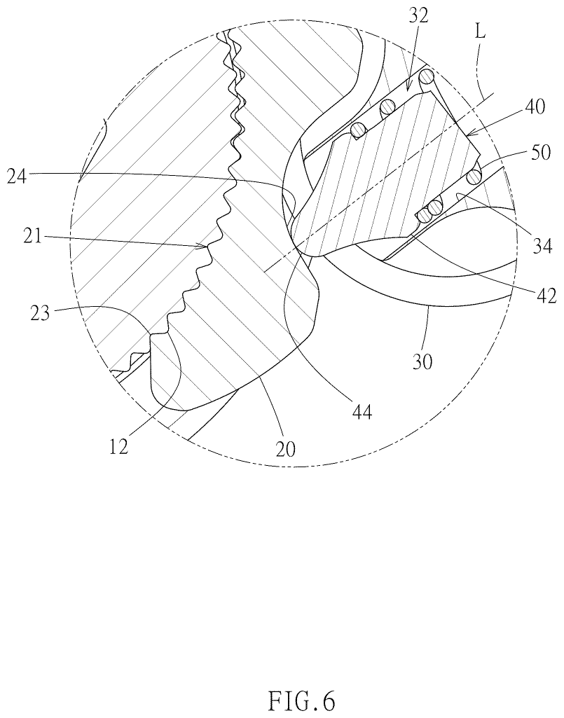

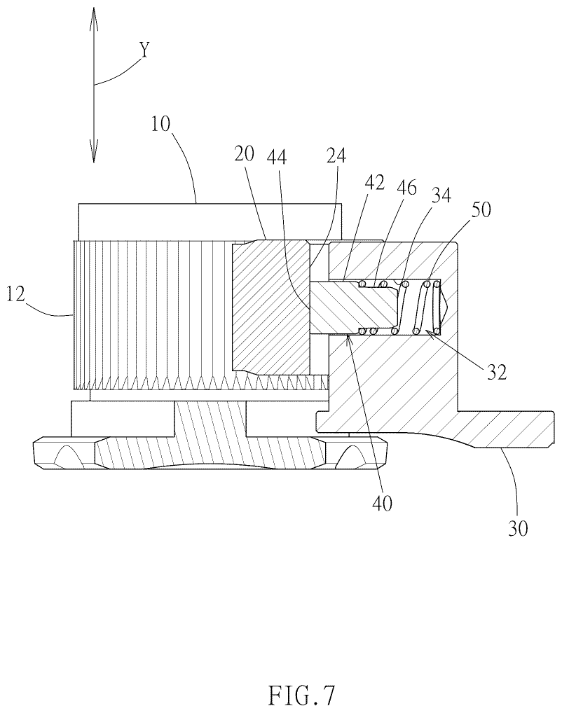

Referring to FIGS. 1 to 7, Embodiment 1 of the direction-reversing detent structure is disposed within a ratchet wrench. The ratchet wrench comprises a ratchet gear 10. The ratchet gear 10 is configured for socket-connection with a driven tool (not shown), thereby enabling the driven tool to be rotationally driven. The driven tool is typically a socket tool for engaging a nut or a bolt. A lateral outer periphery of the ratchet gear 10 is formed with a plurality of ratchet teeth 12. The ratchet gear 10 and Embodiment 1 may be jointly disposed within a cavity (not shown) formed in the ratchet wrench.

Embodiment 1 comprises a pawl 20, a reversing lever 30, a detent plunger 40, and a detent spring 50. The pawl 20 is interposed between the ratchet gear 10 and the reversing lever 30. The pawl 20 has a tooth-engaging side 21 and a cam side 22 that are opposite to each other. The tooth-engaging side 21 is adjacent to an outer surface of the ratchet gear 10 and is formed with a plurality of pawl teeth 23. A selected plurality of the pawl teeth 23 is configured to selectively engage corresponding ones of the ratchet teeth 12. The cam side 22 is formed with a first cam surface 24 and a second cam surface 25.

The reversing lever 30 is disposed adjacent to the cam side 22 of the pawl 20. The reversing lever 30 defines a bore 32, the bore 32 extending from an end of the reversing lever 30 proximate to the cam side 22 of the pawl 20 into an interior of the reversing lever 30. The bore 32 is closed at an end of the reversing lever 30 distal from the cam side 22.

The detent plunger 40 and the detent spring 50 are respectively disposed within the bore 32. The reversing lever 30 defines the bore 32 and provides a cylindrical bore wall 34. The cylindrical bore wall 34 surrounds a radial outer periphery of the detent plunger 40. The detent plunger 40 may comprise a cylindrical plunger body 42 disposed within the bore 32. The cylindrical bore wall 34 surrounds a radial outer periphery of the plunger body 42, thereby enabling the detent plunger 40 to rotate about its axial direction.

The plunger body 42 may alternatively be configured with a polygonal radial cross-section, or with a radial outer periphery formed by a plurality of teeth circumferentially distributed therearound. In such alternative configurations, the polygonal plunger body 42 or the plunger body 42 formed with the plurality of teeth contacts the cylindrical bore wall 34, such that the detent plunger 40 remains rotatable about its axial direction. These configurations constitute multiple alternative embodiments derived from variations of Embodiment 1, which are not illustrated in the drawings.

An axial end of the detent plunger 40 extends outwardly from the reversing lever 30 to form a contact surface 44. The contact surface 44 is configured to selectively engage the first cam surface 24 or the second cam surface 25. The detent spring 50 resiliently engages both the detent plunger 40 and the reversing lever 30, thereby providing an elastic force that urges and remains the contact surface 44 into engagement with either the first cam surface 24 or the second cam surface 25.

Each of the pawl teeth 23, the first cam surface 24, and the second cam surface 25 extends along a first direction Y. An axial direction of the detent plunger 40, the bore 32, and the plunger body 42 extends along a second direction X. The tooth-engaging side 21 and the cam side 22 of the pawl 20 are spaced apart along the second direction X. The first direction Y is orthogonal to the second direction X.

The contact surface 44 has an arcuate profile and extends along the first direction Y. A central portion of the contact surface 44 is closer to the cam side 22 than are opposite end portions of the arcuate contact surface 44. As a result, the contact surface 44 and either the first cam surface 24 or the second cam surface 25 establish linear contact along the first direction Y.

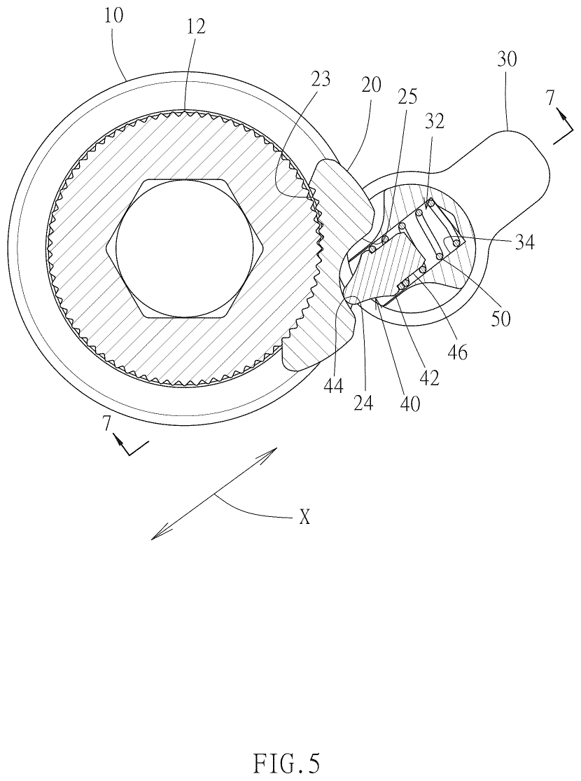

As shown in FIGS. 5, 6, and 7, the contact surface 44 and the first cam surface 24 establish linear contact along the first direction Y. Through such linear contact, a bearing force of the detent plunger 40 on the pawl 20 constrains the pawl 20 from rotating relative to the ratchet gear 10 in the first direction Y. This arrangement enhances the stability of the engagement between the pawl 20 and the ratchet gear 10. Consequently, the plurality of pawl teeth 23 and the plurality of ratchet teeth 12 that form the engagement relationship between the pawl 20 and the ratchet gear 10 are enabled to form a complete engagement in the first direction Y. When an acting force transmitted from the driven tool through the ratchet gear 10 is applied to the engaged ratchet teeth 12 and pawl teeth 23, each of the ratchet teeth 12 and each of the pawl teeth 23 are therefore less susceptible to structural damage.

The first cam surface 24 and the second cam surface 25 being formed as arcuate cam surfaces represent a preferred implementation. Accordingly, when the detent plunger 40 is assembled with the reversing lever 30, if the contact surface 44 does not initially extend in alignment with the first direction Y, then upon subsequent engagement of the contact surface 44 with the first cam surface 24 or the second cam surface 25, a relative force exerted by the pawl 20 on the detent plunger 40 can, through the arcuate profile of the respective cam surface acting via the contact surface 44, urge the detent plunger 40 to slightly rotate. This ensures that the contact surface 44 achieves linear contact with the first cam surface 24 or the second cam surface 25 along the first direction Y, thereby improving operational convenience in assembling the detent plunger 40 with the reversing lever 30.

An engagement region between the contact surface 44 and the first cam surface 24 or the second cam surface 25 is generally located at lateral portions of the contact surface 44 through which a central axis L of the detent plunger 40 passes, and is adjacent to the central axis L. When the ratchet wrench is operated under load, the engagement region between the contact surface 44 and the first cam surface 24 or the second cam surface 25 tends to shift in a direction away from the central axis L.

The detent spring 50 bears against the plunger body 42. The detent plunger 40 further comprises a stem 46, one end of the stem 46 being connected to the plunger body 42. The stem 46 extends along the second direction X. An outer diameter of the stem 46 is smaller than an outer diameter of the plunger body 42, and the detent spring 50 is disposed surrounding the stem 46.

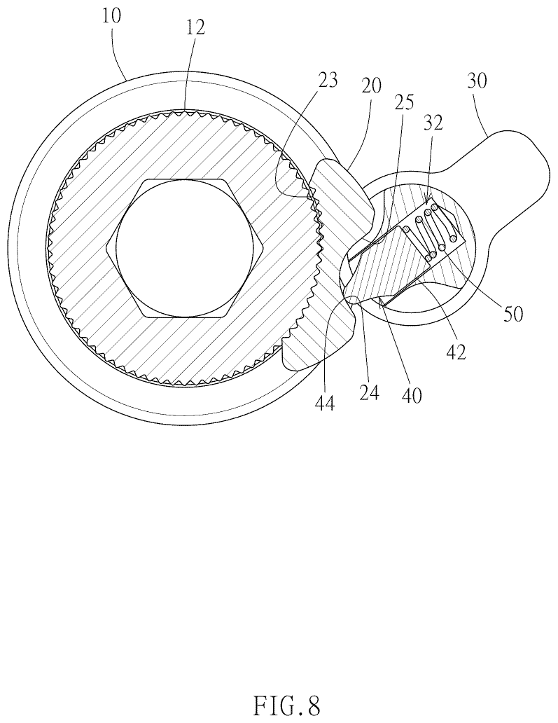

As shown in FIG. 8, Embodiment 2 primarily differs from Embodiment 1 in that the detent plunger 40 of Embodiment 2 does not include the stem 46 present in Embodiment 1.

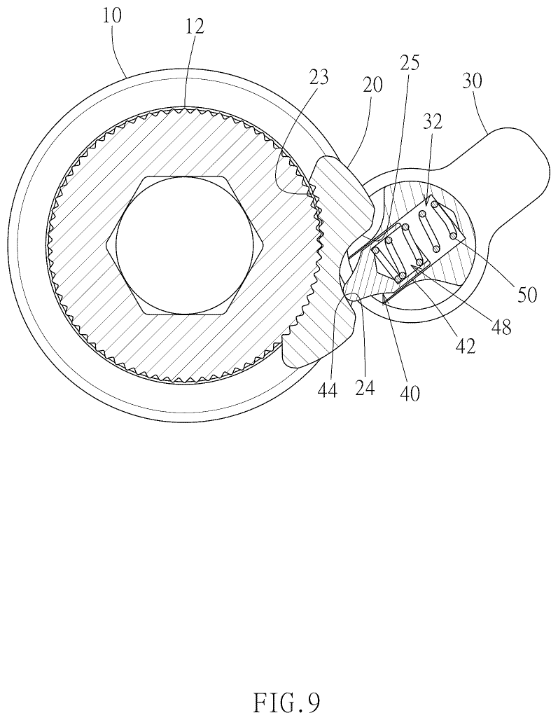

As shown in FIG. 9, Embodiment 3 primarily differs from Embodiment 2 in that the plunger body 42 defines a recess 48. The recess 48 extends to an axial end of the detent plunger 40 distal from the contact surface 44. The detent spring 50 extends into the recess 48 to resiliently bear against the detent plunger 40.

What is claimed is:

1. A direction-reversing detent structure for ratchet wrenches, the direction-reversing detent structure being disposed in a ratchet wrench, the ratchet wrench comprising a ratchet gear, the ratchet gear being configured for socket-connection with a driven tool, a lateral outer periphery of the ratchet gear being formed with a plurality of ratchet teeth;
the direction-reversing detent structure comprising a pawl, a reversing lever, a detent plunger, and a detent spring,
wherein the pawl is interposed between the ratchet gear and the reversing lever, the pawl having a tooth-engaging side and a cam side that are opposite to each other, the tooth-engaging side being adjacent to an outer surface of the ratchet gear and being formed with a plurality of pawl teeth, a selected plurality of the pawl teeth being configured to selectively engage corresponding ones of the ratchet teeth, the cam side being formed with a first cam surface and a second cam surface;
the reversing lever being disposed adjacent to the cam side of the pawl, the reversing lever defining a bore, the bore extending from an end of the reversing lever proximate to the cam side of the pawl into an interior of the reversing lever, the bore being closed at an end of the reversing lever distal from the cam side;
the detent plunger and the detent spring being respectively disposed within the bore, the reversing lever defining the bore and providing a cylindrical bore wall surrounding a radial outer periphery of the detent plunger, thereby enabling the detent plunger to rotate about an axial direction thereof, an axial end of the detent plunger extending outwardly from the reversing lever to form a contact surface, the contact surface being configured to selectively engage the first cam surface or the second cam surface, the detent spring resiliently engaging both the detent plunger and the reversing lever so as to urge the contact surface into engagement with either the first cam surface or the second cam surface;
each of the pawl teeth, the first cam surface, and the second cam surface extending along a first direction, an axial direction of the detent plunger and the bore extending along a second direction, the tooth-engaging side and the cam side of the pawl being spaced apart along the second direction, the first direction being orthogonal to the second direction; and
the contact surface having an arcuate profile and extending along the first direction, a central portion of the contact surface being positioned closer to the cam side of the pawl than are opposite end portions of the contact surface, such that the arcuate cam surface of the first cam surface or the second cam surface urges the detent plunger to slightly rotate via the contact surface, thereby enabling the contact surface and the first cam surface or the second cam surface to establish linear contact along the first direction and improving operational convenience in assembling the detent plunger with the reversing lever.

2. The direction-reversing detent structure for ratchet wrenches according to claim 1, wherein the detent plunger comprises a cylindrical plunger body disposed within the bore, the plunger body extending along the second direction, and the cylindrical bore wall surrounding a radial outer periphery of the plunger body.

3. The direction-reversing detent structure for ratchet wrenches according to claim 2, wherein the detent spring bears against the plunger body.

4. The direction-reversing detent structure for ratchet wrenches according to claim 3, wherein the detent plunger further comprises a stem, one end of the stem being connected to the plunger body, the stem extending along the second direction, an outer diameter of the stem being smaller than an outer diameter of the plunger body, and the detent spring being disposed surrounding the stem.

5. The direction-reversing detent structure for ratchet wrenches according to claim 2, wherein the plunger body defines a recess, the recess extending to an axial end of the detent plunger distal from the contact surface, and the detent spring extending into the recess to resiliently bear against the detent plunge.
